(19) United States
(12) Patent Application Publication
(10) Pub. No.: US 2013/0036429 A1
(43) Pub. Date: Feb. 7, 2013

(54) SYSTEM AND METHOD FOR CIRCULATING MAP-BASED APPLICATION

(71) Applicant: Young-Hoon LEE, Daejeon (KR)

(72) Inventor: Young-Hoon LEE, Daejeon (KR)

(73) Assignee: KT CORPORATION, Seongnam-city (KR)

(21) Appl. No.: 13/565,091

(22) Filed: Aug. 2, 2012

(30) Foreign Application Priority Data
Aug. 2, 2011 (KR) 10-2011-0077116

(51) Int. Cl. G06F 9/46

(52) U.S. Cl. 719/318

(57) ABSTRACT

A system and a method for circulating a map-based App are provided. In a method in which an App circulation system circulates an App including position information, when a smart terminal is connected, position information of the smart terminal is acquired. The App circulation system searches for one of more Apps having position information within a predetermined radius of the smart terminal based on the acquired position information. The found location App is displayed in the smart terminal on a map based on a position or augmented reality.

### CROSS-REFERENCE TO RELATED APPLICATION

This application claims the benefit of priority from the Korean Patent Application No. 10-2011-0077116 filed in the Korean Intellectual Property Office on Aug. 2, 2011, the entire disclosure of which is incorporated herein by reference in its entirety.

### BACKGROUND

(a) Field

Exemplary embodiments broadly relate to a system and a method for circulating a map-based application (hereinafter, referred to as an “App”).

(b) Description of the Related Art

Presently, actively developed and available smart phones or smart terminals provide various applications. A user can buy or obtain for free and download various multimedia contents and applications using an online market such as an App store or an Android market and install and use the various multimedia contents and Apps on a smart terminal.

However, in the related art, Apps are circulated only based on a simple search or a recommendation using semantic search technique at an online market.

Therefore, there is a need in the related art to improve the circulation method of an App and to circulate an App for a smart terminal with various methods and techniques.

The above information disclosed in this Background section is only for enhancement of understanding of the background and therefore it may contain information that does not form the prior art that is already known in this country to a person of ordinary skill in the art.

### SUMMARY

It is an aspect to provide a system and a method for circulating a map-based App which enables users to easily receive the necessary Apps taking user's current environment into consideration. It is an aspect to provide a system and a method which deviates from an Apps circulation method which uses existing simple search, by displaying and providing an App for a smart terminal in a map or in augmented reality based on position information corresponding to the App.

It is an aspect of an exemplary embodiment to provide an App circulation system that circulates an App.

According to an aspect of an exemplary embodiment, the App circulation system includes: a location App register that registers a location application hat is input from the outside or that converts a general application to a location application and registers the converted general application; and a location App download unit that displays at least one found location application based on position information of the smart terminal among location applications that are registered by the location App register, where the at least one found location application is displayed on a map in the smart terminal based on a position or augmented reality.

The location App download unit may provide to the smart terminal a circulation App which circulates one or more location applications and which display a location application based on position information of the smart terminal when the smart terminal is connected using the circulation App.

The App circulation system may further include a location App development support unit that includes a location App component that provides logic and an application programming interface (API) for developing a location App and that provides the location App component according to a request of an external developer.

The App circulation system may further include: a map database (DB) that stores map data for displaying location Apps on a map; a location App DB that stores a location App that is registered through the location App register; a general App DB that stores a general App that is registered by the location App register; and a location App information DB that stores information related to the stored location App and information related to the stored general App.

The location App register may include an App register that requests a test by transferring a location App to the location App download unit and that performs a registration processing of the location App, if results of the test indicate no errors; an App converter that converts the general App to the location App based on additional input information and that performs a registration processing of the location converted general application, wherein the additional input information includes position information and an annotation image; and an App information classification unit that stores the location App transferred from the App register in the location App DB and that extracts the position information and the annotation image in the location App and that stores the position information and the annotation image in the location App information DB and that stores the general App transferred from the App converter in the general App DB and that stores information in the location App information DB.

The App converter may transfer the general App to the location App download unit, request a test, and perform the registration processing of the general App, if results of the test indicate no errors.

The location App download unit may include an App download unit that acquires position information of the smart terminal when the smart terminal is connected; an App search unit that searches for a location App having corresponding location within a predetermined radius using the location App information DB based on the acquired position information and that transfers at least one found location App to the App download unit; and an adjustment unit that adjusts a size of an annotation image of a location App to be displayed using map information stored in the map DB, wherein the App download unit may display the found location App transferred from the App search unit based on a position or augmented reality using map data that are stored in the map DB.

The App download unit may test whether the location App transferred from the location App register is displayed on the map according to the corresponding position information and whether the location App can be downloaded, and may transfer the results of the test to the location App register.

The location App information DB may include an identifier field that represents an identifier which may identify the location App or the general App and which is generated by linking longitude and latitude coordinates, which are the position information of a corresponding application; an App name field that represents a name of the corresponding application; an App storage position information field that represents a storage location of the corresponding application; an annotation image storage position information field that represents a storage location of an annotation image of the corresponding application; and an App detailed information field that represents information that describes the corresponding application.

According to yet another aspect of an exemplary, embodiment a method of circulating location Apps is provided.

The method includes receiving a registration request for a location App or a general App from an outside; testing whether the location App or the general App is displayable on a map and whether the location App or the general App is downloadable according to position information of the location App or the general App; and registering, if results of the test indicate no errors, the location App or the general App.

The receiving the registration request may include receiving, when an App for which a registration is requested is a general App, position information and an annotation image corresponding to the general App may be input together.

The registering the location App or the general App may include when an App for which a registration is requested is a general App, the general App may be registered by converting position information and an annotation image corresponding to the general App to a location App.

The method may further include prior to receiving the registration request for the location application or the general application, providing to an external developer a location App component that provides logic and an application programming interface (API) for developing the location App or for converting the general application to the location application according to a request from the external developer.

According to yet another exemplary embodiment, a method of circulating an App (hereinafter, referred to as a “location App”) is provided.

The method may include acquiring, when a smart terminal is connected, position information of the smart terminal; searching for a location App having position information within a predetermined radius based on the acquired position information; and displaying the found location App in the smart terminal based on a position or augmented reality using a map.

The acquiring the position information may include providing location App to the smart terminal when the smart terminal is connected to an App circulation system using a circulation App.

The displaying the found location App in the smart terminal may include displaying an annotation image corresponding to the location App on the map or based on the augmented reality.

The displaying the found location App in the smart terminal may include adjusting a size of the displayed annotation image according to magnification power of the map that is displayed in the smart terminal.

The acquiring the position information may include obtaining permission from a user of the smart terminal to acquire the position information which is a current location of the smart terminal and acquiring the position information of the smart terminal if the permission is obtained.

According to exemplary embodiments, users can receive Apps based on position information corresponding to an App by deviating from a circulation method in which only existing simple searches are used to provide the Apps.

Further, users can easily receive Apps related to their current living environment.

### BRIEF DESCRIPTION OF THE DRAWINGS

FIG. 1 is a block diagram illustrating a configuration of a map-based App circulation system according to an exemplary embodiment.

FIG. 2 is a view illustrating a location App information database according to an exemplary embodiment.

FIG. 3 is a flowchart illustrating a method of developing a location App, by a developer, in a map-based App circulation system according to an exemplary embodiment.

FIG. 4 is a flowchart illustrating a method of registering a location App in a map-based App circulation system according to an exemplary embodiment.

FIG. 5 is a flowchart illustrating a method of converting and registering a general App to a location App in a map-based App circulation system according to an exemplary embodiment.

FIG. 6 is a flowchart illustrating a method of downloading a location App to a smart terminal in a map-based App circulation system according to an exemplary embodiment.

FIG. 7 is a diagram illustrating a method of storing information at a location App information DB according to an exemplary embodiment.

FIG. 8 is a view illustrating a map-based location App display in a location App circulation system according to an exemplary embodiment.

FIG. 9 is a view illustrating a location App display based on augmented reality in a location App circulation system according to an exemplary embodiment.

FIG. 10 is a flow diagram illustrating searching for and installing a download type location App in a location App circulation system according to an exemplary embodiment.

FIG. 11 is a diagram illustrating a method of installing a download type location App in a smart terminal according to an exemplary embodiment.

FIG. 12 is a flow diagram illustrating searching for and installing an In-App type location App in a location App circulation system according to an exemplary embodiment.

FIG. 13 is a diagram illustrating a method of installing an In-App type location App in a smart terminal according to an exemplary embodiment.

### DETAILED DESCRIPTION OF EXEMPLARY EMBODIMENTS

In the following detailed description, only certain exemplary embodiments have been shown and described, simply by way of an illustration. As those skilled in the art would realize, the described exemplary embodiments may be modified in various different ways, all without departing from the spirit or scope of an inventive concept. Accordingly, the drawings and description are to be regarded as illustrative in nature and not as restrictive. Like reference numerals designate analogous elements throughout the specification.

In addition, in the entire specification, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification are units for processing at least one function and operation and can be implemented by hardware components or software components and combinations thereof.

Further, a smart terminal is an intelligent terminal that adds a computer support function such as Internet communication information search to a mobile phone and further has a large capacity memory and a high performance central processing unit (CPU), compared with an existing mobile terminal, and includes an operating system (OS) for supporting execution of various applications, voice/data communication, and interlock with a personal computer (PC). When such a smart terminal is used, Internet may be freely used unlike in an existing mobile terminal. Particularly, a smart terminal can download and install an external App that the user wants.

Hereinafter, a map-based App circulation system according to an exemplary embodiment will be described with reference to the drawings.

In an exemplary embodiment, a position information-based App includes determining position information (an address or a global positioning system (GPS)) of the real world. This position information-based App is included in a general App used in a smart terminal, and may be referred to as a “location App”.

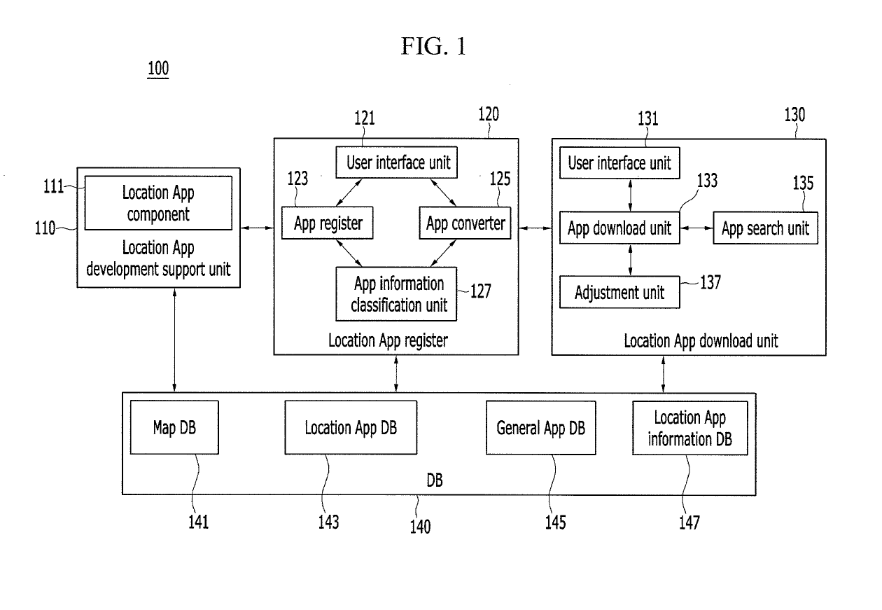

FIG. 1 is a block diagram illustrating a configuration of a map-based App circulation system according to an exemplary embodiment.

As shown in FIG. 1, an App circulation system 100 according to an exemplary embodiment includes a location App development support unit 110, a location App register 120, a location App download unit 130, and a database (hereinafter, referred to as a “DB”) 140.

The location App development support unit 110 stores a location App component 111 that provides logic and an application programming interface (API) necessary for developing a location App, connects to location App developers using a wireless network, and provides the stored location App component 111 to the location App developers according to a request, and the location App developers download the location App component 111 and develop a location App. Here, it is described that the location App development support unit 110 includes the location App component 111, but it will become more readily apparent to a person of an common skill in the art that the location App development support unit 110 further includes a configuration for receiving a location App component providing request from external developers and providing the location App component 111.

The location App register 120 receives and registers a location App that is provided by an external developer using the wireless network or converts and registers a general App to a location App. Here, an action in which the location App register 120 converts and registers a general App to a location App corresponds to an action of receiving position information and an annotation image that can display a general App on a map while receiving a general App from the outside and to an action of registering the position information and the annotation image as a location App by linking the two.

The location App register 120 classifies the registered location Apps according to information of a location App and stores the registered location Apps in the DB 140.

Further, before storing a location App, the location App register 120 transfers a location App in which a registration is requested to the location App download unit 130, and tests whether the location App is accurately displayed at a corresponding position on a map and whether an error exists in the downloaded location App. Only when a result of the testing indicates that an error does not exist in the downloaded location App, the location App register 120 stores a corresponding location App and completes a registration process.

The location App register 120 includes a user interface unit 121, an App register 123, an App converter 125, and an App information classification unit 127.

The user interface unit 121 provides a user interface for providing a location App to external developers using the wireless network.

The App register 123 receives an input of requesting a registration of a location App from an external App developer using the user interface unit 121 and performs a registration process for the location App. In such a registration process, the input location App is transferred to the location App download unit 130 and the above described exemplary test is performed. When a response in which an error does not exist is received from the location App download unit 130, the App register 123 transfers the corresponding location App to the App information classification unit 127.

The App converter 125 is used when registering a general App to a location App. The App converter 125 receives an input of a general App to be registered, position information, and an annotation image corresponding to the general App from an external App developer using the user interface unit 121. The App converter 125 performs a registration process of the general App. Such a registration process is a request to perform the above described exemplary test by transferring the input general App, position information, and an annotation image corresponding to the general App to the location App download unit 130 and a transfer of the general App, position information, and an annotation image corresponding to the general App to the App information classification unit 127 when no errors exist as a result of a test of the general App.

The App information classification unit 127 receives a location App that is transferred from the App register 123, stores the location App at the DB 140, extracts and classifies information that is related to position information (latitude and longitude) and an annotation image that is included in the location App, and stores the information in the DB 140.

Further, the App information classification unit 127 receives a general App that is transferred from the App converter 125, stores the general App in the DB 140, classifies information that is related to position information (latitude and longitude) and an annotation image corresponding to the general App, and stores the information in the DB 140.

The location App download unit 130 provides a location App circulation App for using a map-based App circulation service to a smart terminal using the wireless network according to an exemplary embodiment, and when the user is connected using the smart terminal based on execution of such a location App circulation App, the location App download unit 130 displays location Apps having position information within a predetermined radius from the smart terminal based on position information of the smart terminal on a map, extracts a location App that is selected by the user on the map from the DB 140, and provides the location App to the smart terminal of the user. Here, a selection on the smart terminal may be the user's selection according to, for example, map sweeping and tapping in the smart terminal.

The location App download unit 130 tests whether a location App that is transferred to register a location App from the location App register 120 is accurately displayed on a map according to corresponding position information and whether the location App can be downloaded, and transfers a test result to the location App register 120. Here, the location App is displayed on a map according to position information, and it can be tested whether the location App can be downloaded using an already well-known method and thus a detailed description thereof will be omitted.

When a location App is displayed on a map in the user smart terminal according to a connection of the user smart terminal, the location App download unit 130 adjusts and displays a size of an annotation image of the location App according to a map magnification power.

Further, the location App download unit 130 may display a location App based on augmented reality according to a connection of the user smart terminal. Such a display based on augmented reality is already well known and therefore a detailed description thereof will be omitted. When displaying a location App based on augmented reality, by measuring a distance between the user smart terminal and the location App, a size of an annotation image is adjusted and displayed according to the distance.

The location App download unit 130 includes a user interface unit 131, an App download unit 133, an App search unit 135, and an adjustment unit 137.

The user interface unit 131 provides a user interface for providing a location App download service to the user smart terminal using the wireless network 200.

When the smart terminal 300 is connected using the wireless network 200, the App download unit 133 acquires position information of the smart terminal, transfers the acquired position information to the App search unit 135, displays location Apps that are found by the App search unit 135 on a map, extracts a location App that is selected by the user from the DB 140 using the smart terminal, and provides the location App to the smart terminal of the user using the wireless network. Here, a generally known technology may be used to acquire by the App download unit 133 position information of the smart terminal.

The App search unit 135 searches for a location App having position information within a predetermined radius based on position information that is transferred from the App download unit 133 and transfers the location App to the App download unit 133.

When a location App that is found in the App download unit 133 is displayed on a map and is displayed in the user smart terminal, the adjustment unit 137 adjusts a size of an annotation image of the location App according to map magnification power that is displayed on the smart terminal and provides the image to the App download unit 133.

When a location App is transferred to register the location App from the location App register 120, the App download unit 133 tests whether the location App is accurately displayed on a map according to position information corresponding to the location App and whether the location App can be downloaded, and transfers a test result to the location App register 120.

The DB 140 includes a map DB 141, a location App DB 143, a general App DB 145, and a location App information DB 147.

The map DB 141 stores map data that are used for displaying location Apps based on a map. Already well-known map data may be used as map data and therefore a detailed description thereof will be omitted.

In order to display a map-based App according to an exemplary embodiment, the location App DB 143 stores a location App that is manufactured using the location App component 111.

The general App DB 145 stores a general App that is manufactured using a known method instead of a location App that is manufactured using the location App component 111 according to an exemplary embodiment.

The location App information DB 147 stores location App information that enables the location App download unit 130 to display a location App on a map. The location App information DB 147 extracts and stores information such as position information (latitude and longitude) and an annotation image that is included in a location App by the App information classification unit 127 of the location App register 120, or in a general App, the location App information DB 147 stores information such as position information and an annotation image that is input together when registering a general App.

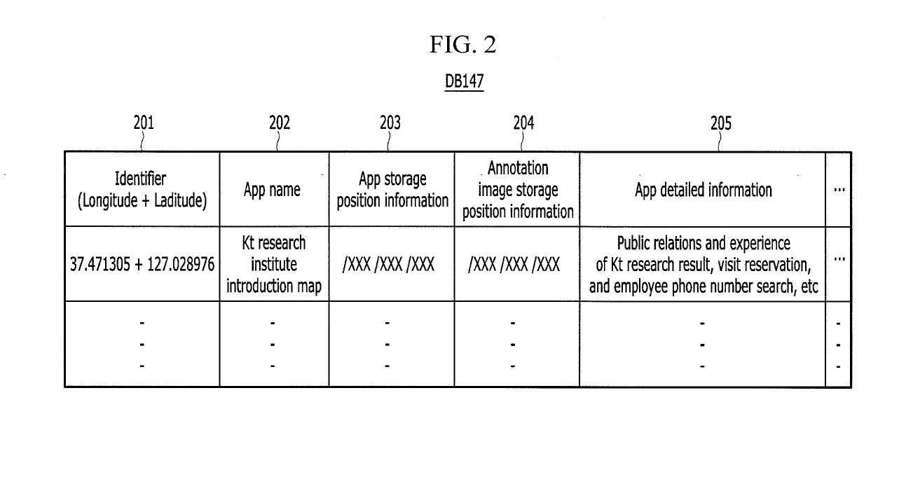

An example of the location App information DB 147 is illustrated in FIG. 2 according to an exemplary embodiment.

As shown in FIG. 2, the location App information DB 147 includes an identifier field 201, an App name field 202, an App storage position information field 203, an annotation image storage position information field 204, and an App detailed information field 205.

The identifier field 201 represents an identifier that can identify a location App or a general App. The identifier is generated by linking longitude and latitude, which is position information, with a symbol to obtain a unique identifier.

The App name field 202 represents a name of a corresponding location App or general App.

The App storage position information field 203 represents a location in memory where a corresponding location App or a corresponding general App is stored.

The annotation image storage position information field 204 represents a location in memory where an annotation image of a corresponding location App or a corresponding general App is stored.

The App detailed information field 205 represents information that describes a location App or a general App. This field may include a short description of the location App or the general App including its functions, attributes, price and so on.

Hereinafter, a method of circulating a map-based App according to an exemplary embodiment will be described in detail with reference to the drawings.

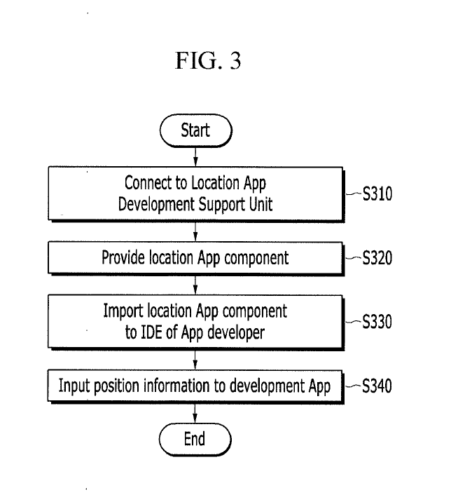

First, a method, according to an exemplary embodiment, in which a location App developer develops a location App will be described with reference to FIG. 3.

When App developers decide to display an App based on a map and to provide the App to the user smart terminal, an App developer connects to the location App development support unit 110 of the App circulation system in order to develop a location App (in operation S310), the location App development support unit 110 provides the location App component 111 that is stored therein to the connected App developer (in operation S320). In this case, because the App developers are subscribed as members of the App circulation system, in order to develop a location App, it is preferable that the App developers connect to the location App development support unit 110 log in, and receive the location App component 111.

The App developers import a location App component that is provided from the location App circulation system to an integrated development environment (IDE) (in operation S330) and input position information to a development App using a library of the location App component 111 (in operation S340), thereby completing a location App.

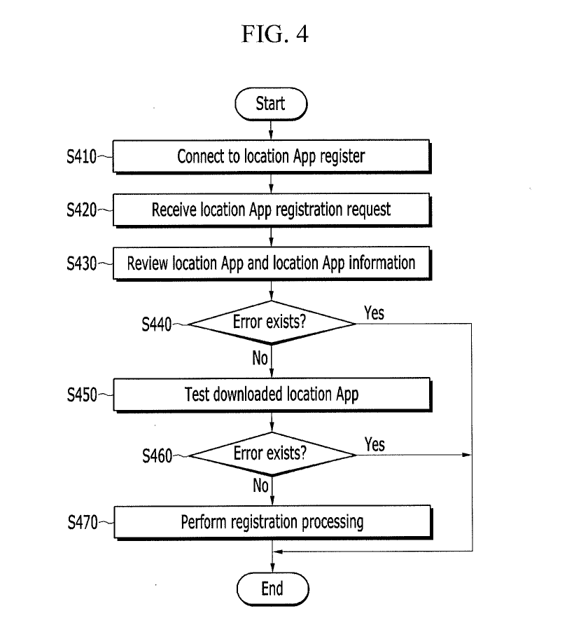

Next, a method of registering a location App at the location App circulation system according to an exemplary embodiment will be described with reference to FIG. 4.

According to an exemplary method of developing a location App that is described with reference to FIG. 3, in order for a developer of a location App to register the developed location App at the App circulation system, by connecting to the location App register 120, the developer requests a registration of the location App (in operation S410).

Therefore, the App register 123 of the location App register 120 receives a) an input of information (hereinafter, referred to as “location App information”) related to a location App that needs to be registered, for example, an App name, App detailed information, receives b) an upload of a location App to register, and receives c) a location App registration request (in operation S420).

Thereafter, the App register 123 reviews the uploaded location App and the input location App information (in operation S430), and determines whether an error exists in the uploaded location App and the input location App information (in operation S440), and if an error does not exist in the uploaded location App and the input location App information (No in operation S440), the App register 123 transfers the location App and the input location App information to the location App download unit 130, requests a test, and receives a test result (in operation S450). If an error exists (Yes in operation S440), the registration process is terminated.

The location App download unit 130 determines whether an error exists in the location App (in operation S460), and if an error does not exist in the location App (No in operation S460), the App register 123 performs a registration processing of a location App in which a registration is requested (in operation S470). Here, in a registration processing, the App register 123 transfers a location App to be registered and location App information, to the App information classification unit 127. The App information classification unit 127 receives the location App, stores the location App at the location App DB 143 of the DB 140, and stores position information and location App information that is extracted from the location App as information corresponding to the location App at the location App information DB 147.

If an error exists in operation S460 (Yes in operation S460), a registration of the location App is terminated.

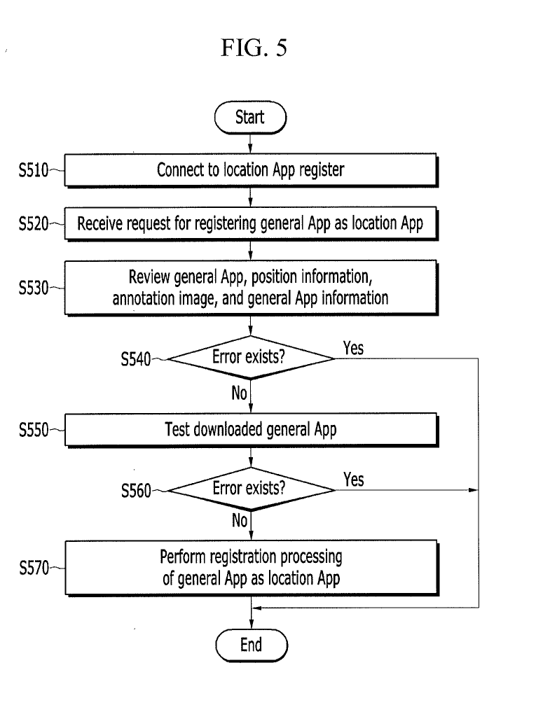

Next, a method of converting a general App to a location App and registering the location App at the location circulation system according to an exemplary embodiment will be described with reference to FIG. 5.

When a user decides to convert a general App to a location App and to register the general App at the location circulation system, the user connects to the location App register 120 and requests to register a general App as a location App (in operation S510).

Therefore, the App converter 125 of the location App register 120 receives an input of position information for displaying a general App (binary) to register the general App on a map, an annotation image, for example, an annotation image of 10×10 size to display on a map, information (hereinafter, referred to as “general App information”) that is related to a general App, for example, an App name, and App detailed information, receives upload of a general App to be registered, and receives a request for registering a general App as a location App (in operation S520). Here, when the user does not know position information such as GPS information and cannot input the position information, the App converter 125 enables input of the position information in a form of an address, and when the address is input, the App converter 125 performs a process of converting the address to corresponding GPS information. The App converter 125 acquires position information of the general App using such an exemplary process.

Thereafter, the App converter 125 reviews an uploaded general App, position information, an annotation image, and input general App information (in operation S530), and the App converter 125 determines whether an error exists in the uploaded general App, the position information, the annotation image, and the input general App information (in operation S540), and if an error does not exist in the uploaded general App (No in operation S540), the position information, the annotation image, and the input general App information, the App converter 125 transfers the general App, the position information, the annotation image, and the general App information to the location App download unit 130, requests a test, and receives a test result (in operation S550). If error exists (Yes in operation S540), the process terminates.

The App converter 125 determines whether an error exists in the general App, the position information, the annotation image, and the general App information at least based on the test results received from the location App download unit 130 (in operation S560), and if an error does not exist in the general App, the position information, the annotation image, and the general App information, (No in operation S560), the App converter 125 performs a registration processing of a general App for which a registration is requested as a location App (in operation S570). Here, a registration processing corresponds to a processing in which the App converter 125 transfers a general App to be registered, position information, an annotation image, and general App information to the App information classification unit 127 and in which the App information classification unit 127 receives a general App, stores the general App at the general App DB 145 of the DB 140, and stores position information and an annotation image of the general App and general App information as information corresponding to the general App at the location App information DB 147.

If an error exists in operation S560 (Yes in operation S560), a registration processing of a general App as a location App is terminated.

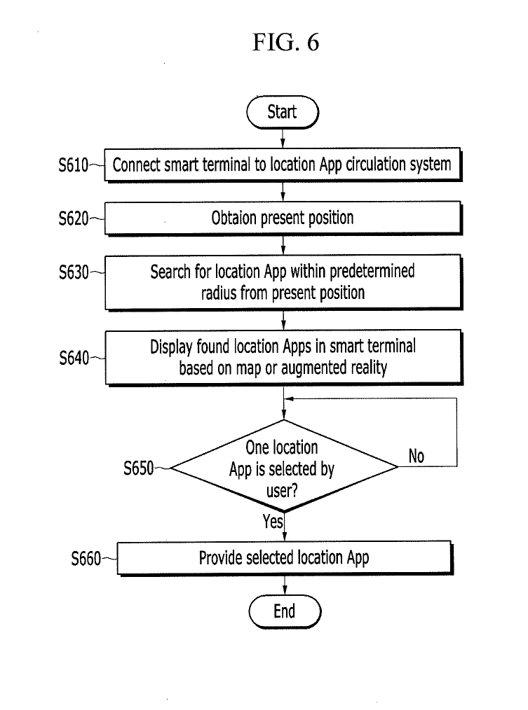

Next, a method of downloading a location App to a smart terminal according to an exemplary embodiment will be described with reference to FIG. 6.

It is assumed that the smart terminal that wants to receive a map-based location App service according to an exemplary embodiment is in a state in which a location App circulation App that can receive a map-based location App service is downloaded from a market and installed on the smart terminal according to an exemplary embodiment.

As the location App circulation App is executed by the user of the smart terminal, when the smart terminal 300 is connected to the location App circulation system using the wireless network 200 (in operation S610), the App download unit 133 of the location App download unit 130 obtains a present position of the smart terminal (in operation S620), transfers the obtained position information to the App search unit 135, and enables a search for a location App. Here, before obtaining position information of the smart terminal, it is preferable to request permission for acquiring a present position and when permission from the user of the smart terminal is received, obtaining the current position information.

The App search unit 135 searches for a location App (including a general App) having position information within a predetermined radius, for example, 1 Km based on position information that is transferred from the App download unit 133 through the location App information DB 147 (in operation S630), and when information of the found location App is transferred to the App download unit 133, the App download unit 133 displays location Apps within a radius of 1 Km from a present position together with the map in a display of the smart terminal using the information of the found location App and map data that are stored in the map DB 141 (in operation S640).

It is determined whether one location App is selected by the user of the smart terminal from location Apps that are displayed on the map (in operation S650), and if one location App is selected from location Apps that are displayed on the map by the user of the smart terminal 300, the App download unit 133 extracts the selected location App from the location App DB 143 or the general App DB 145 and provides the selected location App to the smart terminal (in operation S660). Here, the user of the smart terminal can search for a location App of a peripheral region by sweeping a map that is displayed on the smart terminal. In this case, the App download unit 133 searches again for location Apps that are included within a changed area on the map according to the user's sweeping through the App search unit 135, displays the location Apps on the map of the smart terminal, adjusts a size of an annotation image of location Apps to be displayed on the map using the adjustment unit 137 when a radius distances or map magnification power is changed by sweeping, and displays the image on the map. Further, even when a location App is displayed in the smart terminal based on augmented reality and even when a virtual reality user interface (UI) that is displayed in the smart terminal is changed according to a direction movement of the smart terminal, the smart terminal 300 may display location Apps that are searched for again or adjusted according to the changed environment.

Therefore, after the user of the smart terminal installs the downloaded location App in the smart terminal according to the above method, the user can perform a restaurant reservation or a coupon download function in real time using a function of the location App.

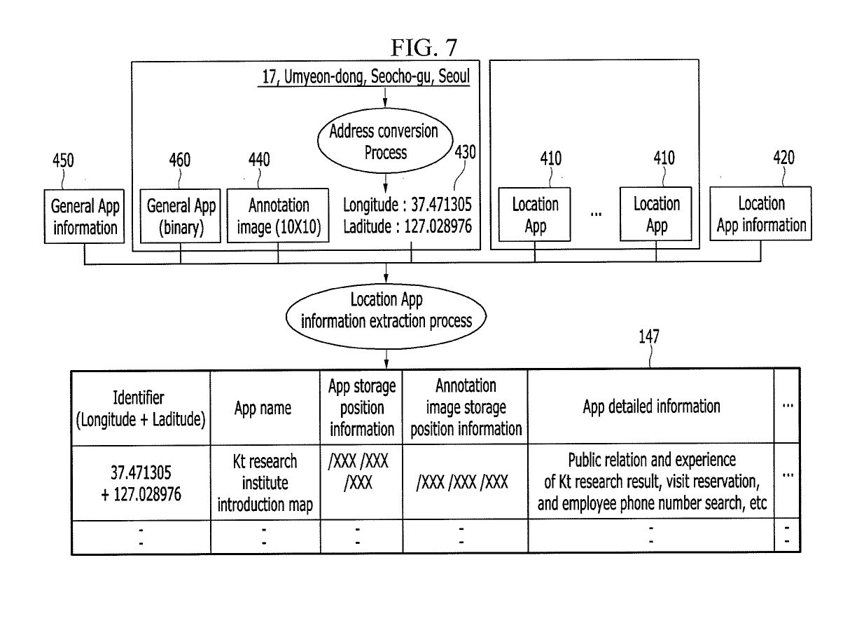

FIG. 7 is a diagram illustrating an example of a method of storing information at the location App information in a storage unit such as DB 147 according to an exemplary embodiment.

When registering a location App, the App information classification unit 127 extracts position information from the registered location App 410 and stores corresponding information in each field of the location App information DB 147 using location App information 420 that is input from the smart terminal.

Further, when registering a general App as a location App, the App information classification unit 127 stores corresponding information in each field of the location App information DB 147 using position information 430 (an address is converted to position information) that is input together with a general App 460, an annotation image 440, and general App information 450.

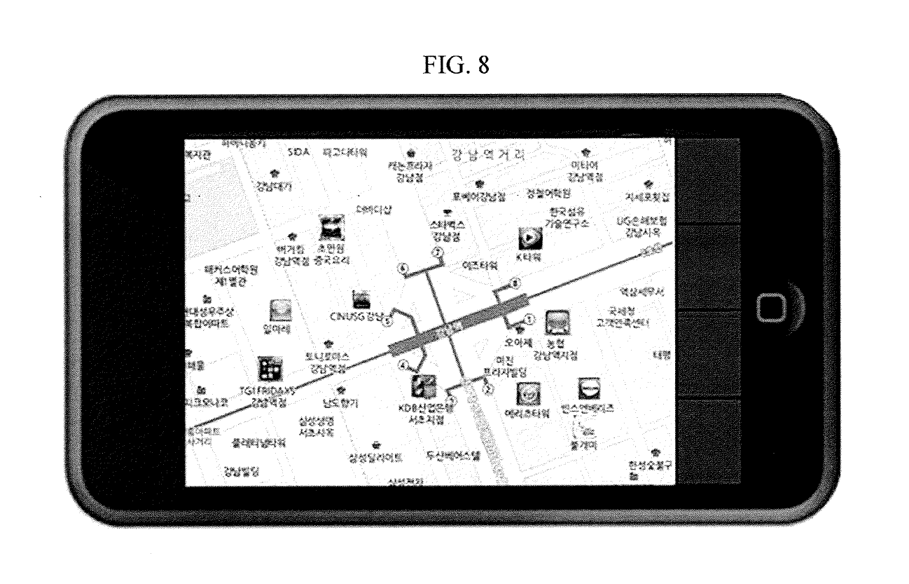

FIG. 8 illustrates an example of a map-based location App display in the location App circulation system according to an exemplary embodiment.

As shown in FIG. 8, in order to download a location App, when the smart terminal connects to the location App circulation system, a present position of the smart terminal is acquired, and location Apps within a predetermined radius from a present position are displayed on a map of a corresponding region, or when the user sweeps the displayed map and selects a specific region, a location App belonging to a corresponding region is displayed on a map. To display a location App on a map is to display an annotation image of the location App in a region on a map corresponding to position information of the location App.

In this way, when an annotation image of the location App is displayed on a map, if the user touches the annotation image of the location App, detailed information of the location App and an installation button are shown, and if the user presses the installation button, the location App is downloaded from the location App circulation system and is installed in the smart terminal.

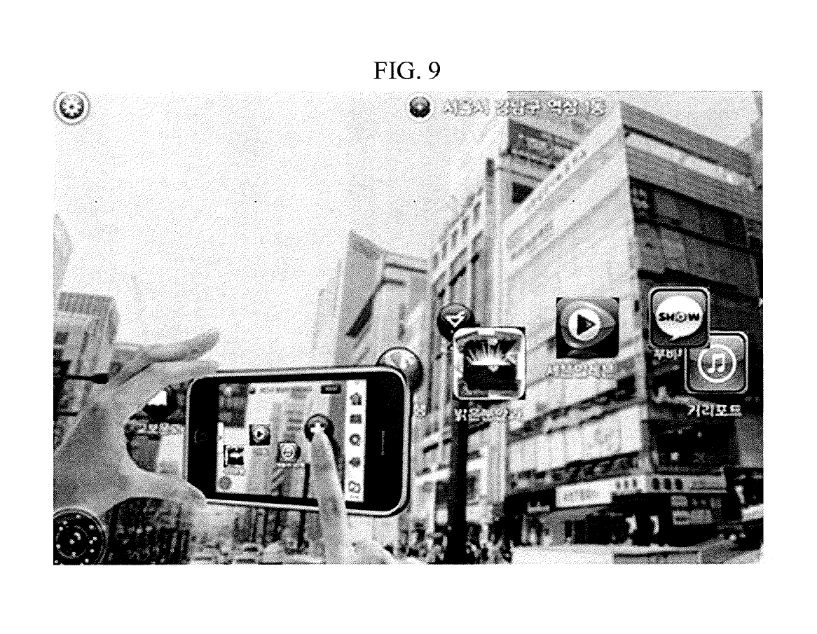

FIG. 9 illustrates an example of a location App display based on augmented reality in the location App circulation system according to an exemplary embodiment.

As shown in FIG. 9, in order to download a location App, when the smart terminal connects to the location App circulation system, a present position of the smart terminal is acquired, and location Apps within a predetermined radius from the present position are displayed using an augmented reality UI corresponding to a corresponding region. To display a location App using the augmented reality UI is to display an annotation image of the location App at a position on the augmented reality UI corresponding to position information of the location App.

In this way, when the annotation image of the location App is displayed using the augmented reality UI, if the user touches an annotation image on the augmented reality UI of a location App, detailed information and an installation button of the location App are shown, and if the user presses the installation button, the corresponding location App is downloaded from the location App circulation system and is installed in the smart terminal.

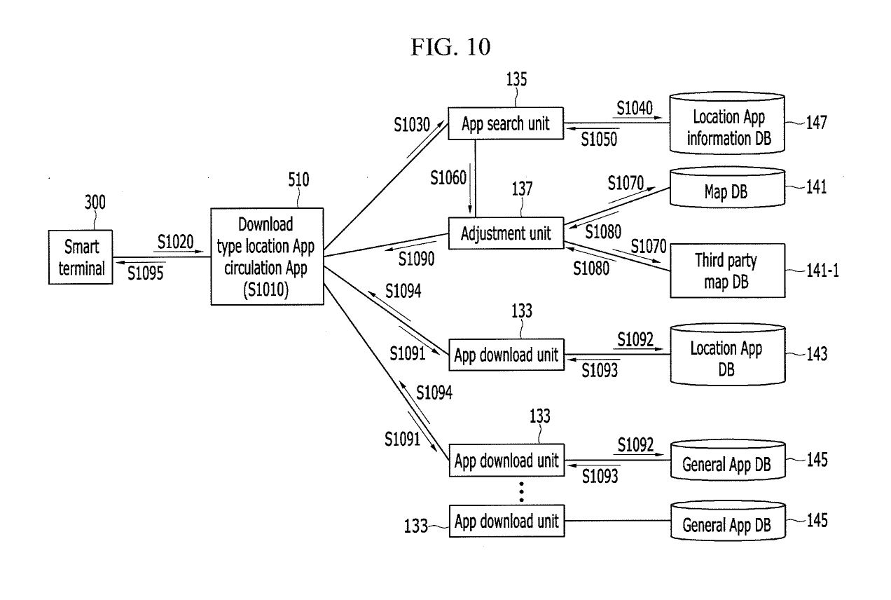

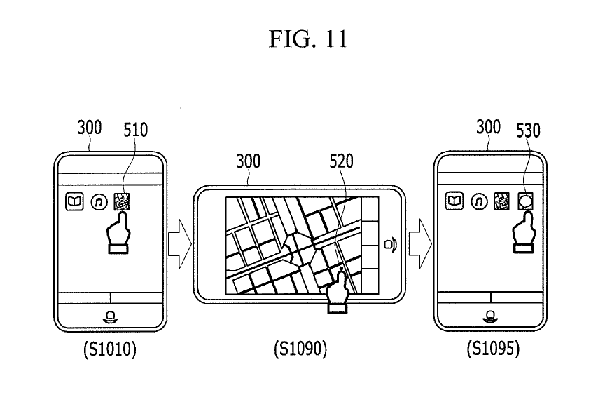

FIG. 10 is a flow diagram illustrating an example of searching for and installing a download type location App in the location App circulation system according to an exemplary embodiment, and FIG. 11 is a diagram illustrating an example of installing a download type location App in a smart terminal 300 according to an exemplary embodiment.

As shown in FIG. 10, when a download type location App circulation App is downloaded by the user of the smart terminal 300 and is installed at the smart terminal 300, an icon 510 of the App is displayed in the smart terminal 300, e.g., as shown in FIG. 11 (operation S1010).

When the icon 510 of the App is selected for example by touching and executed by the user (in operation S1020), the circulation App 510 acquires position information of the smart terminal 300 and provides the position information to the App search unit 135 of the location App circulation system (in operation S1030).

The App search unit 135 searches for a peripheral location App using information that is stored at the location App information DB 147 based on the received position information (in operations S1040) and provides results to the App search unit 135 (in operation S1050). The App search unit 135 then provides information of the found location App to the adjustment unit 137 in order to display the found location Apps on the map (in operation S1060).

The adjustment unit 137 requests (in operation S1070) and receives (in operation S1080) a map for displaying in the smart terminal 300, for example, a self map, a third party map to the map DB 141 or a third party map DB 141-1 and adjusts a position for displaying the found location Apps on the received map, thereby displaying the found location Apps with an annotation image 520 on the smart terminal 300 using the UI of the location App circulation App 510 (in operation S1090), as shown in FIG. 11.

Therefore, when the user views location Apps that are displayed in the smart terminal 300 and selects (e.g., by touching) an annotation image of a location App (in operation S1091), the App download unit 133 of the location App circulation system extracts the location App from the location App DB 143 or the general App DB 145 (in operations S1092, S1093), provides the location App to the smart terminal 300 (in operation S1094), and when the smart terminal 300 installs the provided location App, an icon 530 of the location App is displayed in the smart terminal 300 (in operation S1095), as shown in FIG. 11.

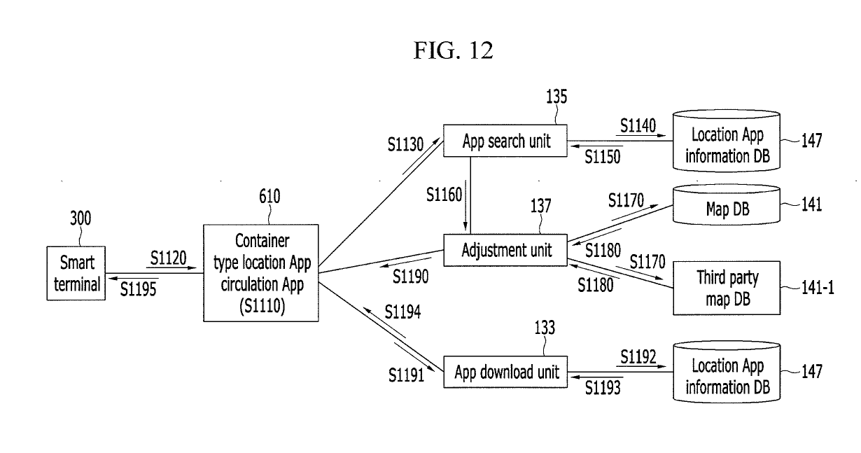

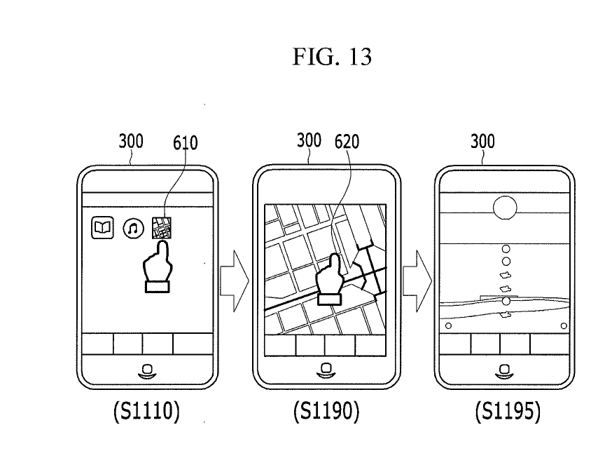

FIG. 12 is a flow diagram illustrating an example of searching for and installing an In-App type location App in the location App circulation system according to an exemplary embodiment, and FIG. 13 is a diagram illustrating an example of installing an in-App type location App in the smart terminal 300 according to an exemplary embodiment. Here, In-App indicates an application, i.e., an App that provides a common service in a form in which a component is inserted into a plurality of unspecified applications.

As shown in FIG. 12, when an In-App type location App circulation App is downloaded by the user of the smart terminal 300 and is installed in the smart terminal 300, an icon 610 of the App is displayed in the smart terminal 300 (in operation S1110), as shown in FIG. 13.

Thereafter, a process from operation S1120 in which the icon 610 of the App is selected e.g. by touching and executed by the user to operation S1191 in which the user views location Apps that are displayed in the smart terminal 300 and selects e.g., by touching an annotation image of a location App necessary for the user is the same as or analogous to a process described in operations S1020 to S1091 with reference to FIGS. 10 and 11 and therefore a detailed description thereof will be omitted.

Thereafter, when the user views location Apps that are displayed in the smart terminal 300 and touches an annotation image of a location App 620 shown in FIG. 13 (in operation S1191), the App download unit 133 of the location App circulation system extracts information and components that are related to the location App from the location App information DB 147 (in operations S1192 and S1193) and provides the information and components to the smart terminal 300 (in operation S1194), and the In-App type location circulation App executes an In-App type location App that is included in an In-App type circulation App with reference to the provided information and components in the smart terminal 300 (in operation S1195), as shown in FIG. 13. Therefore, the user can use a function of a location App within a circulation App without an installation process using the above exemplary process.

In an exemplary embodiment, a smart terminal may be connected to an App circulation system such as the one shown in FIG. 1 which includes all or some of the components shown in FIG. 1 via a wireless network which may include internet.

While exemplary embodiments have been described above, it is understood that an inventive concept is not limited to the disclosed exemplary embodiments, but, on the contrary, is intended to cover various modifications and equivalent arrangements included within the spirit and scope of the appended claims and their equivalents. Moreover, various modifications to these exemplary embodiments will be readily apparent to those skilled in the art, and the generic principles and specific examples defined herein may be applied to other exemplary embodiments.

What is claimed is:

1. An App circulation system comprising:
a location App register that registers a location application that is input from the outside or that converts a general application to a location application and registers the converted location application; and
a location App download unit that displays at least one found location application based on position information of a smart terminal among location applications that are registered by the location App register,
wherein the at least one found location application is displayed on a map in the smart terminal based on a position or an augmented reality.

2. The App circulation system of claim 1, wherein the location App download unit provides to the smart terminal a circulation application which circulates the location applications and displays at least one of the location applications based on position information of the smart terminal when the smart terminal is connected using the circulation application.

3. The App circulation system of claim 1, further comprising a location App development support unit comprising a location App component that provides logic and an application programming interface (API) for developing a location application and that provides the location App component according to a request of an external developer.

4. The App circulation system of claim 1, further comprising:
a map database (DB) that stores map data for displaying the location applications on a map;
a location App DB that stores the registered location application;
a general App DB that stores the general application that is registered by the location App register; and
a location App information DB that stores information related to the registered location application stored in the location App DB and information related to the general application stored in the general App DB.

5. The App circulation system of claim 4, wherein the location App register comprises:
an App register that requests a test by transferring the location application to the location App download unit and that performs a registration processing of the location application, if results of the test indicate no errors;
an App converter that converts the general application to the location application based on additional input information and that performs the registration processing of the converted general application, wherein the additional input information comprises position information and an annotation image; and
an App information classification unit that stores the location application transferred from the App register in the location App DB and that extracts the position information and the annotation image of the location application and that stores the position information and the annotation image in the location App information DB and that stores the general application transferred from the App converter in the general App DB and that stores the input additional information in the location App information DB.

6. The App circulation system of claim 5, wherein the App converter transfers the general application to the location App download unit, requests a test, and performs a registration processing of the general application, if results of the test indicate no errors.

7. The App circulation system of claim 4, wherein the location App download unit comprises:
an App download unit that acquires position information of the smart terminal when the smart terminal is connected;
an App search unit that searches for a location application having corresponding location within a predetermined radius using the location App information DB based on the acquired position information and that transfers at least one found location application to the App download unit; and
an adjustment unit that adjusts a size of an annotation image of the found location application to be displayed using map information stored in the map DB,
wherein the App download unit displays the found location application transferred from the App search unit based on a position or augmented reality using map data that are stored in the map DB.

8. The App circulation system of claim 7, wherein the App download unit tests whether the location application transferred from the location App register is displayed on the map according to the corresponding position information and whether the location application can be downloaded, and transfers the results of the test to the location App register.

9. The App circulation system of claim 4, wherein the location App information DB comprises:
an identifier field that represents an identifier which identifies the location application or the general application and which is generated by linking longitude and latitude coordinates, which are the position information of a corresponding application;
an App name field that represents a name of the corresponding application;
an App storage position information field that represents a storage location of the corresponding application;
an annotation image storage position information field that represents a storage location of an annotation image of the corresponding application; and
an App detailed information field that represents information that describes the corresponding application.

10. A method of circulates an application comprising:
receiving a registration request for a location application or a general application from an outside;
testing whether the location application or the general application is displayable on a map and whether the location application or the general application is downloadable according to position information of the location application or the general application; and
registering, if results of the testing indicate no errors, the location application or the general application.

11. The method of claim 10, wherein the receiving the registration request comprises
when an application for which a registration is requested is a general application, position information and an annotation image corresponding to the general application are input together.

12. The method of claim 11, wherein the registering the location application or the general application comprises
when an application for which a registration is requested is a general application, the general application is registered by converting position information and an annotation image corresponding to the general application to a location application.

13. The method of claim 10, further comprising, prior to receiving the registration request for the location application or the general application, providing to an external developer a location App component that provides logic and an application programming interface (API) for developing the location application or for converting the general application to the location application according to a request from the external developer.

14. A method of circulating an application comprising:
acquiring, when a smart terminal is connected, position information of the smart terminal;
searching for a location application having position information within a predetermined radius based on the acquired position information; and
displaying the found location application in the smart terminal based on a position or augmented reality using a map.

15. The method of claim 14, wherein the acquiring the position information comprises
providing the location application to the smart terminal when the smart terminal is connected to an App circulation system using a circulation application.

16. The method of claim 14, wherein the displaying the found location application in the smart terminal comprises
displaying an annotation image corresponding to the location application on a map or based on augmented reality.

17. The method of claim 16, wherein the displaying the found location application in the smart terminal comprises
adjusting a size of the displayed annotation image according to magnification power of the map that is displayed in the smart terminal.

18. The method of claim 14, wherein the acquiring the position information comprises
obtaining permission from a user of the smart terminal to acquire the position information which is a current location of the smart terminal and acquiring the position information of the smart terminal if the permission is obtained.

19. An apparatus for circulating location applications comprising:
a memory which stores a plurality of location applications with respective corresponding position information; and
a processor which obtains position information of a user terminal and which selects at least one of the plurality of location application based on proximity of the position information of a respective location application to the obtained position of the user terminal.

20. The apparatus of claim 19, further comprising an output unit which outputs the at least one selected location application and map information such that the selected location application is displayed on a map or augmented reality map in the user terminal.

21. The apparatus of claim 19, wherein the processor receives a general application not linked to a map location with additional information, processes the additional information to extract the position information and an annotated image, and links the general application to the position information and the annotated image so as to convert the general application to a location related application.

22. The App circulation system of claim 1, wherein the location App download unit receives a selection of one of the found location application from a user and provides the selected one location application to the smart terminal.

23. The App circulation system of claim 1, wherein the found application are displayed in the smart terminal within at the map provided by a circulation application that is downloaded and installed in the smart terminal.
